(19) United States
(12) Patent Application Publication
(10) Pub. No.: US 2026/0237311 A1
(43) Pub. Date: Aug. 13, 2026

(54) INFORMATION PROCESSING DEVICE, MOBILE BODY CONTROL METHOD, AND MOBILE BODY CONTROL PROGRAM

(71) Applicant: MITSUBISHI HEAVY INDUSTRIES, LTD., Tokyo (JP)

(72) Inventors: Kenji Takao, Tokyo (JP); Hirotaka Okazaki, Tokyo (JP); Naoki Yamada, Tokyo (JP)

(73) Assignee: MITSUBISHI HEAVY INDUSTRIES, LTD., Tokyo (JP)

(21) Appl. No.: 19/156,781

(22) PCT Filed: Aug. 30, 2023
(86) PCT No.: PCT/JP2023/031518

§ 371 Date: Aug. 14, 2025

(30) Foreign Application Priority Data
Mar. 31, 2023 (JP) 2023-058457

(51) Int. Cl. G08G 9/02

(52) U.S. Cl. CPC G08G 9/02

(57) ABSTRACT

The information processing device includes: an acquisition unit that acquires at least first schedule information including a target position and a schedule time zone of work of a first mobile body that is a manned vehicle; and a processing unit that analyzes interference of work between the first mobile body and a second mobile body that is an unmanned vehicle on the basis of the acquired first schedule information.

### TECHNICAL FIELD

The present disclosure relates to an information processing device, a moving body control method, and a moving body control program.

### BACKGROUND ART

Control for suppressing interference between moving bodies is known. For example, PTL 1 discloses a configuration for avoiding interference between an unmanned vehicle that autonomously travels in a mine and a manned vehicle that travels in the mine with a driver on board.

### CITATION LIST

### Patent Literature

[PTL 1] Japanese U.S. Pat. No. 6,368,259

### SUMMARY OF INVENTION

### Technical Problem

In a case where work is performed using a manned vehicle and an unmanned vehicle, a configuration is required in which interference can be flexibly suppressed in both the manned vehicle and the unmanned vehicle depending on a work situation while the work is efficiently performed.

The present disclosure has been made in view of the above, and an object of the present disclosure is to provide an information processing device, a moving body control method, and a moving body control program, with which it is possible to flexibly suppress interference between a manned vehicle and an unmanned vehicle depending on a work situation while work is efficiently performed.

### Solution to Problem

An information processing device according to the present disclosure includes an acquisition unit that acquires at least first planned information including a target position and a planned time period of work of a first moving body that is a manned vehicle, and a processing unit that analyzes interference in work between the first moving body and a second moving body that is an unmanned vehicle, based on the acquired first planned information.

A moving body control method according to the present disclosure includes a step of acquiring at least first planned information including a target position and a planned time period of work of a first moving body that is a manned vehicle, and a step of analyzing interference in work between the first moving body and a second moving body that is an unmanned vehicle, based on the acquired first planned information.

A moving body control program according to the present disclosure causes a computer to execute a process of acquiring at least first planned information including a target position and a planned time period of work of a first moving body that is a manned vehicle, and a process of analyzing interference in work between the first moving body and a second moving body that is an unmanned vehicle, based on the acquired first planned information.

### Advantageous Effects of Invention

According to the present disclosure, it is possible to flexibly avoid interference between a manned vehicle and an unmanned vehicle depending on a work situation while work is efficiently performed.

### BRIEF DESCRIPTION OF DRAWINGS

FIG. 1 is a schematic diagram of a movement control system according to the present embodiment.

FIG. 2 is a schematic diagram of a configuration of a first moving body.

FIG. 3 is a schematic diagram of a configuration of a second moving body.

FIG. 4 is a schematic block diagram of a control device of the second moving body.

FIG. 5 is a schematic block diagram of a management device.

FIG. 6 is a schematic block diagram of an information processing device.

FIG. 7 is a diagram showing an example of a work order.

FIG. 8 is a diagram showing an example of an analysis result displayed on a display unit.

FIG. 9 is a diagram schematically showing an example of a workable area.

FIG. 10 is a diagram schematically showing another example of an operation of a moving body.

FIG. 11 is a diagram schematically showing an example of candidates for first planned information displayed on the display unit.

FIG. 12 is a flowchart showing an example of an operation of the information processing device according to the present embodiment.

### DESCRIPTION OF EMBODIMENTS

Hereinafter, a preferred embodiment of the present disclosure will be described in detail with reference to the accompanying drawings. The present disclosure is not limited to the embodiment. In addition, in a case where there are a plurality of embodiments, the present disclosure also includes a combination of the embodiments.

### Movement Control System

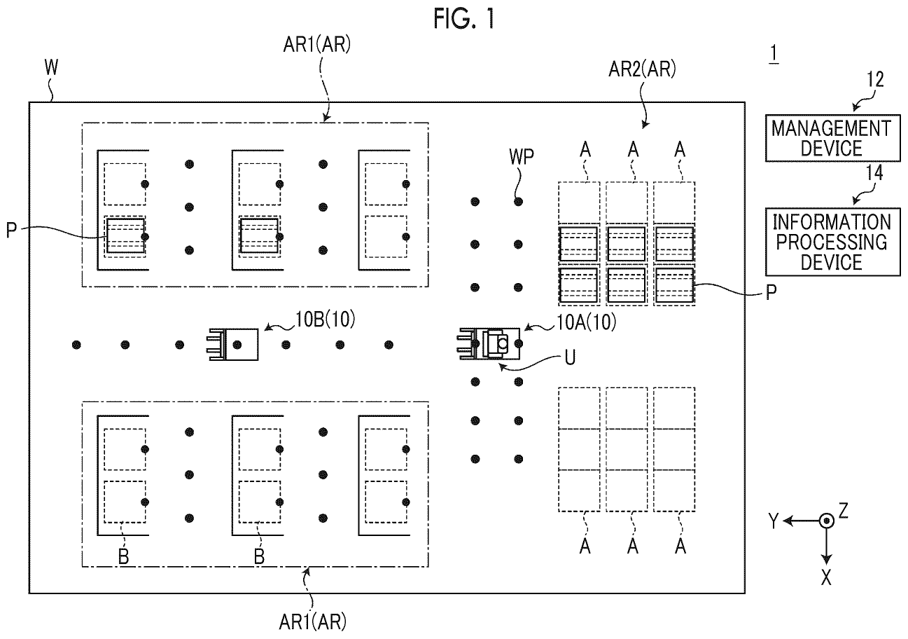

FIG. 1 is a schematic diagram of a movement control system according to the present embodiment. As shown in FIG. 1, a movement control system 1 according to the present embodiment includes a moving body 10, a management device 12, and an information processing device 14. The movement control system 1 is a system that controls a movement of the moving body 10 belonging to a facility W. The facility W is, for example, a facility that is involved in physical distribution management, such as a warehouse, but may be any facility that operates the moving body 10. In the movement control system 1, the moving body 10 picks up and transports an object P disposed in a work region AR of the facility W. The work region AR is a region where the object is installed or the moving body 10 moves, and is, for example, a floor surface of the facility W. In the present embodiment, the object P transported by the moving body 10 is a transport target with cargo loaded on a pallet. Note that the object P is not limited to a transport target with cargo loaded on the pallet, and may be in any form. For example, the object P may be only the cargo without the pallet. In addition, the moving body 10 is not limited to a moving body that transports the object P, and may be a device that moves in the facility W for any purpose.

### Work Region

As shown in FIG. 1, the work region AR is set in the facility W. The work region AR is a region where the moving body 10 of the present embodiment performs predetermined work such as loading and unloading work. The work region AR includes a first region ARI and a second region AR2.

Hereinafter, one direction along a floor surface of the work region is referred to as an X direction, and a direction along the floor surface that intersects the direction X is referred to as a Y direction. In the present embodiment, the Y direction is a direction orthogonal to the X direction. The X direction and the Y direction may be referred to as directions along a horizontal plane. In the X direction and the Y direction, a direction of an arrow is defined as a + direction (or a + side), and a direction opposite to the + direction is defined as a − direction (or a − side). In addition, a direction orthogonal to the X direction and the Y direction, more specifically, a direction toward an upper side in a vertical direction, is referred to as a Z direction. In addition, in the present embodiment, the term “position” refers to a position (coordinates) in a coordinate system (coordinate system of the first region AR1) on a two-dimensional plane in the first region AR1, unless otherwise specified. In addition, the term “posture (orientation)” of the moving body 10 or the like refers to an orientation of the moving body 10 or the like in the coordinate system of the first region AR1, and indicates a yaw angle (rotation angle) of the moving body 10 when the X direction is set to 0° in a case where the moving body 10 or the like is viewed in the Z direction, unless otherwise specified.

The first region AR1 is, for example, a region where the object P loaded on a transport vehicle V or the object P unloaded from the transport vehicle V is disposed. A plurality of disposition regions A in which the object P is disposed are provided in the first region AR1. The disposition region A is a region set for disposing the object P, and can be said to be a region where the object P is likely to be installed. The shape and size of the disposition region A are set in advance. In the example of FIG. 1, the disposition region A is rectangular, but the shape and the size may be arbitrary. In addition, the disposition region A is partitioned for each object P, and one object P is disposed in each disposition region A. Depending on a status of the facility W, each disposition region A may or may not have the object P disposed therein. In the example of FIG. 1, the disposition regions A are set to be disposed side by side in the Y direction, but the way of arrangement and the number of the disposition regions A may be arbitrary.

The second region AR2 is provided at a position adjacent to the first region AR1. In the example of FIG. 1, the second region AR2 is located on the-Y side of the first region AR1. The second region AR2 includes a storage region B. The storage region B stores the object P. The storage region B is not limited to a configuration in which the storage regions B are disposed side by side in the X direction and the Y direction, and the storage regions B may be disposed side by side in the Z direction, for example, as in a shelf.

### Waypoint

In the work region AR, a waypoint WP is set for each position (coordinates). A movement route of the moving body 10 is set to connect the waypoints WP. That is, a route connecting the waypoints WP through which the moving body 10 is planned to pass is a movement route of the moving body 10. The waypoint WP is set according to a layout of the work region AR. For example, the waypoints WP may be set in a matrix pattern in a movable region of the moving body 10 in the work region AR. In addition, the waypoint WP is set in advance according to a position where the object P is disposed in a parking region ARV. In addition, the waypoint WP can be set to correspond to the disposition region A or the like in which the object P is disposed in the work region AR. For example, the waypoint WP can be set at a position (coordinates) corresponding to each disposition region A.

### Moving Body

In the present embodiment, the moving body 10 includes a first moving body 10A which is a manned vehicle that moves in response to an operation of a driver and a second moving body 10B which moves autonomously.

### First Moving Body

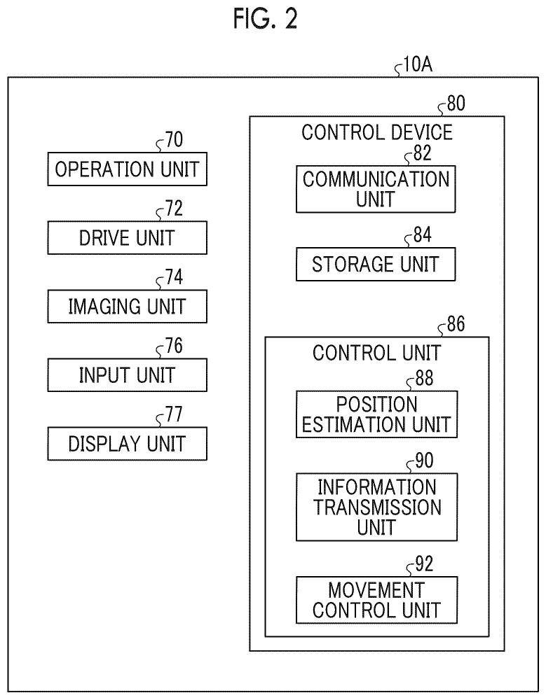

FIG. 2 is a schematic diagram of a configuration of a first moving body. The first moving body 10A as a manned vehicle is a device that moves in response to an operation of a driver U. For example, the first moving body 10A moves by being operated by the driver U aboard the first moving body 10A. Note that the present invention is not limited to this, and the first moving body 10A may move by being remotely operated by the driver U not aboard the first moving body 10A. In addition, in the present embodiment, the first moving body 10A is a device capable of transporting an object. Furthermore, in the present embodiment, the first moving body 10A is a forklift. Note that the first moving body 10A is not limited to a forklift that transports an object, and may be any device that can move in response to an operation of the driver U.

As shown in FIG. 2, the first moving body 10A includes an operation unit 70, a drive unit 72, an imaging unit 74, an input unit 76, a display unit 78, and a control device 80. The operation unit 70 is an interface mechanism that receives an operation from the driver U, and may include, for example, a steering wheel, an accelerator, and a brake. The drive unit 72 is a drive mechanism that moves the first moving body 10A. The first moving body 10A moves when the drive unit 72 is driven by the operation of the driver U received by the operation unit 70.

The imaging unit 74 is disposed, for example, in a head guard or the like of the first moving body 10A. The imaging unit 74 is installed facing a ceiling and images the ceiling. The imaging unit 74 outputs imaging data to the control device 80.

The input unit 76 receives information input by the driver U. Examples of the information input by the driver U include first planned information and the like, which will be described below. The input unit 76 may be various input devices such as a touch panel and a keyboard.

The display unit 78 displays information such as text and an image. As the display unit 78, various displays such as a liquid crystal display are used.

The control device 80 is a device that controls the first moving body 10A. The control device 80 is a computer, and includes a communication unit 82, a storage unit 84, and a control unit 86. The communication unit 82 is a module used by the control unit 86 for communicating with an external device such as the information processing device 14, and may include, for example, an antenna or the like. A communication method via the communication unit 82 is wireless communication in the present embodiment, but the communication method may be arbitrary, The storage unit 84 is a memory that stores various types of information such as calculation contents of the control unit 86 and programs, and includes, for example, at least one of a main storage device such as a random access memory (RAM) or a read only memory (ROM) and an external storage device such as a hard disk drive (HDD).

The control unit 86 is a calculation device, and includes, for example, a calculation circuit such as a central processing unit (CPU). The control unit 86 includes a position estimation unit 88, an information transmission unit 90, and a movement control unit 92. The control unit 86 reads out a program (software) from the storage unit 84 and executes the program (software), thereby realizing the position estimation unit 88, the information transmission unit 90, and the movement control unit 92, and executing processes thereof. The control unit 86 may execute the processes with one CPU or may include a plurality of CPUs and may execute the processes with the plurality of CPUs. In addition, at least a part of the position estimation unit 88, the information transmission unit 90, and the movement control unit 92 may be realized by a hardware circuit. In addition, a program for the control unit 86 stored in the storage unit 84 may be stored in a recording medium readable by the control device 80.

The position estimation unit 88 analyzes the imaging data imaged by the imaging unit 74 through image processing or the like. The position estimation unit 88 estimates the position of the first moving body 10A in real time based on an analysis result of the imaging data and a movement situation of the first moving body 10A, such as a speed and a steering angle.

The information transmission unit 90 transmits first moving body information indicating the position and the speed of the first moving body 10A and first planned information of the first moving body to an external device such as the information processing device 14. The movement control unit 92 controls the movement of the first moving body 10A. Specific processing contents thereof will be described below. The movement control unit 92 automatically controls the first moving body 10A, for example, automatically stops the first moving body 10A. Note that, since the first moving body 10A is a manned vehicle, a function for automatically controlling the first moving body 10A is not required, in other words, the first moving body 10A does not need to include the movement control unit 92.

### Second Moving Body

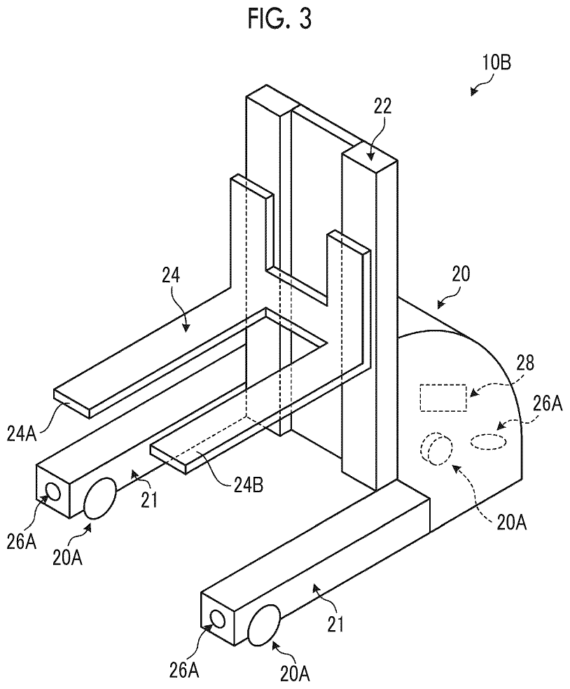

FIG. 3 is a schematic diagram of a configuration of a second moving body. The second moving body 10B as an unmanned vehicle is a device that can move automatically. In the present embodiment, the second moving body 10B is a device capable of transporting an object. Furthermore, in the present embodiment, the second moving body 10B is a forklift, more specifically, a so-called automated guided vehicle (AGV) or an automated guided forklift (AGF). Note that the second moving body 10B is not limited to a forklift that transports an object, and may be any device that can move automatically.

As shown in FIG. 3, the second moving body 10B includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The mast 22 is movably attached to the straddle legs 21 and moves in the front-rear direction of the vehicle body 20. The mast 22 extends along an up-down direction (here, the direction Z) orthogonal to the front-rear direction. The fork 24 is attached to the mast 22 to be movable in the direction Z. The fork 24 may also be movable relative to the mast 22 in a lateral direction (direction intersecting the up-down direction and the front-rear direction) of the vehicle body 20. The fork 24 has a pair of forks 24A and 24B. The forks 24A and 24B extend from the mast 22 toward a rear direction of the vehicle body 20. The fork 24A and the fork 24B are spaced apart from each other in the lateral direction of the mast 22. Hereinafter, in the front-rear direction, a direction on a side on which the fork 24 is not provided in the second moving body 10B is referred to as a front direction, and a direction on a side on which the fork 24 is provided is referred to as a rear direction.

The sensor 26A detects at least one of a position and a posture of an object present around the vehicle body 20. It can also be said that the sensor 26A detects at least one of the position of the object with respect to the second moving body 10B and the posture of the object with respect to the second moving body 10B. In the present embodiment, the sensors 26A are provided at a tip of each straddle leg 21 in the rear direction and on a front direction side of the vehicle body 20. Note that a position where the sensor 26A is provided is not limited to this, and the sensor 26A may be provided at any position, and the number of the sensors 26A provided may also be arbitrary.

The sensor 26A is, for example, a sensor that emits laser light. The sensor 26A emits laser light while performing scanning in one direction (here, the lateral direction) and detects the position and the orientation of the object from reflected light of the emitted laser light. That is, the sensor 26A can also be said to be a so-called two-dimensional (2D)-light detection and ranging (LiDAR). Note that the sensor 26A is not limited to the above and may be a sensor that detects the object using any method, for example, a so-called three-dimensional (3D)-LiDAR that performs scanning in a plurality of directions, a so-called one-dimensional (1D)-LiDAR that does not perform scanning, or a camera.

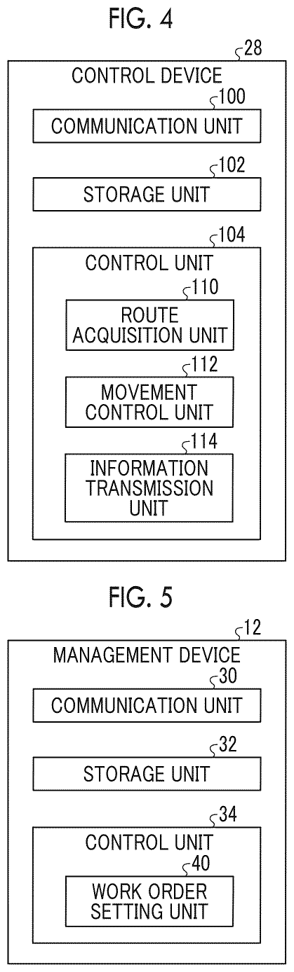

FIG. 4 is a schematic block diagram of a control device of the second moving body. The control device 28 is a device that controls the second moving body 10B. The control device 28 is a computer, and includes a communication unit 100, a storage unit 102, and a control unit 104 as shown in FIG. 4. The communication unit 100 is a module used by the control unit 104 for communicating with an external device such as the information processing device 14, and may include, for example, an antenna. A communication method of the communication unit 100 is wireless communication in the present embodiment, but the communication method may be arbitrary. The storage unit 102 is a memory that stores various kinds of information, such as calculation contents of the control unit 104 and programs, and includes, for example, at least one of a main storage device such as a RAM or a ROM and an external storage device such as an HDD.

The control unit 104 is a calculation device, and includes, for example, a calculation circuit such as a CPU. The control unit 104 includes a route acquisition unit 110, a movement control unit 112, and an information transmission unit 114. The control unit 104 reads out a program (software) from the storage unit 102 and executes the program (software), thereby realizing the route acquisition unit 110, the movement control unit 112, and the information transmission unit 114, and executing processes thereof. The control unit 104 may execute the processes with one CPU or may include a plurality of CPUs and may execute the processes with the plurality of CPUs. In addition, at least a part of the route acquisition unit 110, the movement control unit 112, and the information transmission unit 114 may be realized by a hardware circuit. In addition, a program for the control unit 104 stored in the storage unit 102 may be stored in a recording medium readable by the control device 28.

The route acquisition unit 110 acquires information on a route along which the second moving body 10B moves, the movement control unit 112 controls a movement mechanism such as a drive unit or steering of the second moving body 10B to control the movement of the second moving body 10B, and the information transmission unit 114 transmits second moving body information indicating a position of the second moving body 10B to an external device such as the information processing device 14. Specific processing contents thereof will be described below.

### Management Device

FIG. 5 is a schematic block diagram of a management device. The management device 12 is a system that manages physical distribution in the facility W. Although the management device 12 is a warehouse control system (WCS) or a warehouse management system (WMS) in the present embodiment, the management device 12 is not limited to the WCS and the WMS and may be any system, for example, a back-end system such as another production management system. A position where the management device 12 is provided is arbitrary, and the management device 12 may be provided in the facility W or may be provided at a location away from the facility W to manage the facility W from that location. The management device 12 is a computer, and as shown in FIG. 5, includes a communication unit 30, a storage unit 32, and a control unit 34.

The communication unit 30 is a module used by the control unit 34 for communicating with an external device such as the information processing device 14, and may include, for example, an antenna. A communication method of the communication unit 30 is wireless communication in the present embodiment, but the communication method may be arbitrary. The storage unit 32 is a memory that stores various kinds of information, such as calculation contents of the control unit 34 and programs, and includes, for example, at least one of a main storage device such as a RAM or a ROM and an external storage device such as an HDD.

The control unit 34 is a calculation device, and includes, for example, a calculation circuit such as a CPU. The control unit 34 includes a work order setting unit 40. The control unit 34 reads out a program (software) from the storage unit 32 and executes the program (software), thereby realizing the work order setting unit 40, and executing a process thereof. The control unit 34 may execute the process with one CPU or may include a plurality of CPUs and may execute the process with the plurality of CPUs. In addition, at least a part of the work order setting unit 40 may be realized by a hardware circuit. In addition, a program for the control unit 34 stored in the storage unit 32 may be stored in a recording medium readable by the management device 12.

The work order setting unit 40 sets a work order of the moving body 10 for each object P. The work order setting unit 40 causes the communication unit 30 to transmit the set work order. The content of the work order will be described below.

The management device 12 may also perform processes other than the setting of the target position. For example, the management device 12 may also set information for controlling a mechanism (for example, an elevator or a door) other than the moving body 10 provided in the facility W.

### Information Processing Device

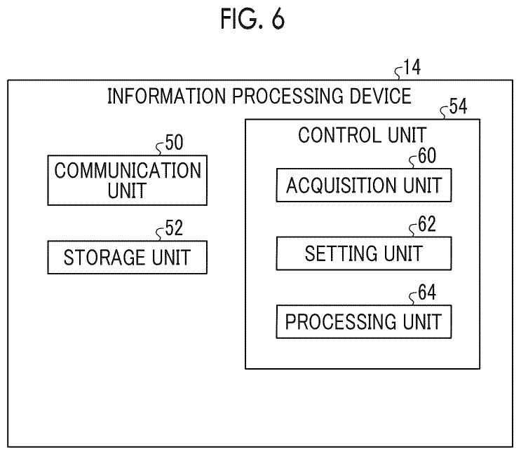

FIG. 6 is a schematic block diagram of an information processing device. The information processing device 14 is a device that processes information regarding the movement of the moving body 10. The information processing device 14 is, for example, a fleet control system (FCS), but is not limited to this, and may be any device that processes the information regarding the movement of the moving body 10. The information processing device 14 is a computer, and includes a communication unit 50, a storage unit 52, and a control unit 54 as shown in FIG. 6. The communication unit 50 is a module used by the control unit 54 for communicating with an external device such as the management device 12 and the moving body 10, and may include, for example, an antenna. A communication method of the communication unit 50 is wireless communication in the present embodiment, but the communication method may be arbitrary. The storage unit 52 is a memory that stores various kinds of information, such as calculation contents of the control unit 54 and programs, and includes, for example, at least one of a main storage device such as a RAM or a ROM and an external storage device such as an HDD.

The control unit 54 is a calculation device, and includes, for example, a calculation circuit such as a CPU. The control unit 54 includes an acquisition unit 60, a setting unit 62, and a processing unit 64. The control unit 54 reads out a program (software) from the storage unit 52 and executes the program (software), thereby realizing the acquisition unit 60, the setting unit 62, and the processing unit 64, and executing processes thereof. The control unit 54 may execute the processes with one CPU or may include a plurality of CPUs and may execute the processes with the plurality of CPUs. In addition, at least a part of the acquisition unit 60, the setting unit 62, and the processing unit 64 may be realized by a hardware circuit. In addition, a program for the control unit 54 stored in the storage unit 52 may be stored in a recording medium readable by the information processing device 14.

The acquisition unit 60 acquires the work order transmitted from the management device 12. The acquisition unit 60 acquires the first work information transmitted from the first moving body 10A. The acquisition unit 60 acquires the second moving body information transmitted from the second moving body 10B. The setting unit 62 sets the second planned information of the second moving body 10B based on the work order. The processing unit 64 analyzes interference between the first moving body 10A and the second moving body 10B. Specific processing contents thereof will be described below.

In the present embodiment, the management device 12 and the information processing device 14 are separate devices, but may be integrated into one device. That is, the management device 12 may have at least some functions of the information processing device 14, and the information processing device 14 may have at least some functions of the management device 12.

### Processing of Movement Control System

Processing contents of the movement control system 1 will be described below.

### Acquisition of First Planned Information

In the first moving body 10A, in a case where the driver U inputs the first planned information to the input unit 76, the information transmission unit 90 of the control unit 86 transmits the input first planned information to the information processing device 14. The first planned information includes information about a target position (first target position) of the work of the first moving body 10A, a planned time period for the work, and a priority (first priority) of the work. The first planned information may include information about the movement route of the first moving body 10A. The first target position may be any position in the facility W. The first target position may be a position where the first moving body 10A performs the work, such as a position of an object to be received by the first moving body 10A or a position of a destination of an object to be transported by the first moving body 10A. The first planned time period may be a time period during which the driver U plans to perform the work using the first moving body 10A. The first priority may be appropriately set depending on a work situation, and, for example, the first priority can be set relatively high in a case of urgent work, and the first priority can be set relatively low in a case of performing normal work. In the information processing device 14, the communication unit 50 receives the first planned information transmitted from the first moving body 10A. The acquisition unit 60 of the control unit 34 acquires the received first planned information.

### Acquisition of Second Planned Information

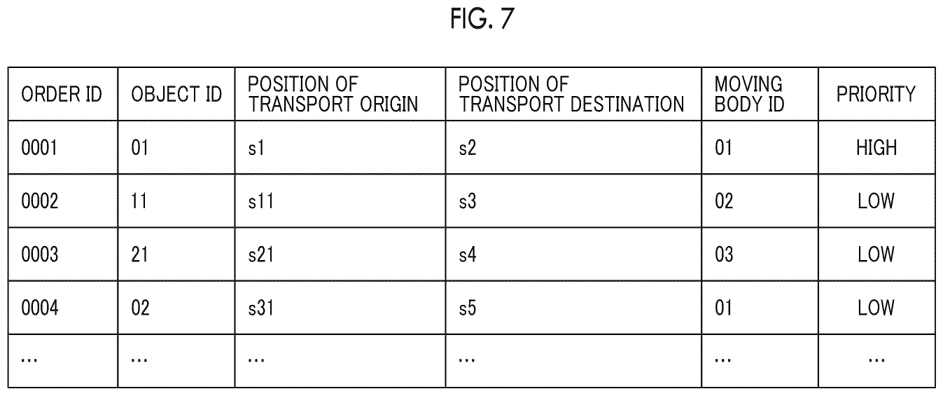

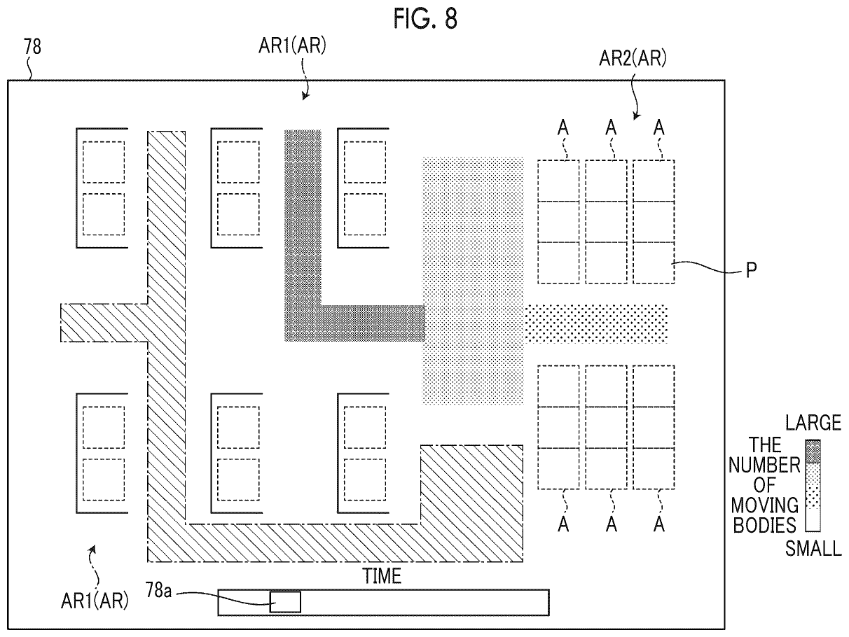

The work order setting unit 40 of the management device 12 sets a work order related to work of the second moving body 10B which is an unmanned vehicle. The work order is set for each object P. FIG. 7 is a diagram showing an example of the work order. As shown in FIG. 7, the work order includes an order ID, an ID of the object P corresponding to the order ID, information on a transport origin and a transport destination, a work priority, and an ID of the moving body 10 to which work is assigned. The work order setting unit 40 causes the communication unit 30 to transmit the set work order.

In the information processing device 14, the communication unit 50 receives the work order. The acquisition unit 60 acquires the received work order. The setting unit 62 generates the second planned information about the work of the second moving body 10B based on the acquired work order. The second planned information includes information about a target position (second target position) of the work of the second moving body 10B, a planned time period for the work (second planned time period), and a priority (second priority) of the work. The second planned information may include information about the movement route of the second moving body 10B. The second target position may be any position in the facility W. The second target position may be a position where the second moving body 10B performs the work, such as a position of an object to be received by the second moving body 10B or a position of a destination of an object to be transported by the second moving body 10B. The second planned time period may be a time period during which the work is planned to be performed by the second moving body 10B. The second priority is a priority set in the work order. The acquisition unit 60 acquires the set second planned information.

### Interference Analysis 1

In the information processing device 14, the processing unit 64 analyzes interference between the first moving body 10A and the second moving body 10B based on the acquired first planned information and second planned information. In a case where the first moving body 10A performs the work according to the first planned information and the second moving body 10B performs the work according to the second planned information, the processing unit 64 analyzes whether or not there is a time period during which a movement route or a target position overlaps between the first moving body 10A and the second moving body 10B.

The processing unit 64 determines which of the first moving body 10A and the second moving body 10B is the moving body 10 that performs work with a higher priority, based on the priority included in the first planned information and the second planned information.

In a case where the priority included in the second planned information is higher than the priority included in the first planned information, the processing unit 64 determines that the second moving body 10B performs the work with the higher priority than the first moving body 10A. In this case, the processing unit 64 transmits the analysis result to the first moving body 10A. In this case, the processing unit 64 can transmit information in which the analysis result and the second planned information are associated with each other by time to the first moving body 10A.

The first moving body 10A receives the analysis result via the communication unit 82. The received analysis result is displayed on, for example, the display unit 78 and is presented to the driver U. FIG. 8 is a diagram showing an example of the analysis result displayed on the display unit 78. FIG. 8 shows a state where the number of the second moving bodies 10B passing per predetermined time is superimposed and displayed on a map of the work region AR. The display unit 78 may also display an indicator 78a together, and slide the indicator 78a to indicate a change in the number of the passing second moving bodies 10B per predetermined time as the time is changed. In addition, a portion (hatched portion surrounded by a one-dot chain line in FIG. 8) representing an area and a movement route in which the first moving body 10A can move may be superimposed on the map of the work region AR based on the analysis result.

The driver U can determine the work content of the first moving body 10A based on the analysis result. For example, in a case where an analysis result indicating that there is a time period during which the movement route or the target position overlaps between the first moving body 10A and the second moving body 10B is presented, the driver U can change the first planned information so as to perform the work in a time period during which the movement route or the target position does not overlap with that of the second moving body 10B.

In addition, in a case where the priority included in the first planned information is higher than the priority included in the second planned information, the processing unit 64 determines that the first moving body 10A performs the work with the higher priority than the second moving body 10B. In this case, the processing unit 64 changes the second planned information of the second moving body 10B such that the second moving body 10B does not interfere with the first moving body 10A that performs the work according to the first planned information, based on the result of the analysis. For example, the processing unit 64 can set a time period during which the first moving body 10A does not perform the work as the time period of the second planned information. The processing unit 64 transmits the changed second planned information to the second moving body 10B. The second moving body 10B receives the transmitted second planned information after adjustment and performs the work based on the received second planned information after adjustment. The processing unit 64 may notify the first moving body 10A of a time period different from the time period set in the second planned information as a workable time period.

### Interference Analysis 2

In the above example, a case where the second planned information is set by the setting unit 62 has been described as an example, but the present disclosure is not limited to this case. For example, in a case where the first planned information is acquired in the information processing device 14 in a state where the second planned information is not set, the processing unit 64 can analyze interference between the first moving body 10A and the second moving body 10B based on the acquired first planned information, and set the second planned information based on a result of the analysis.

In this case, for example, the processing unit 64 calculates a movement route, a target position, and a planned time period that do not overlap the first planned information as an analysis result, based on the acquired first planned information. The setting unit 62 changes the second planned information of the second moving body 10B such that the second moving body 10B does not interfere with the first moving body 10A that performs the work according to the first planned information, based on the result of the analysis. The setting unit 62 can set the second planned information each time the first planned information is acquired.

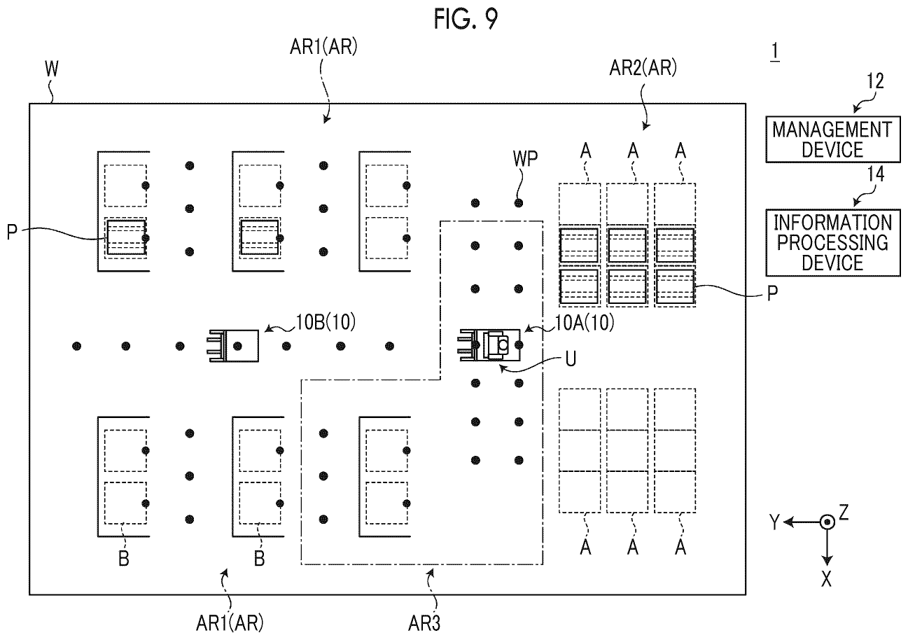

When setting the second planned information, the processing unit 64 can calculate, for example, a workable area in which the first moving body 10A can perform the work, based on the analysis result. FIG. 9 is a diagram schematically showing an example of the workable area. As shown in FIG. 9, a workable area AR3 can be set to a range including, for example, a target position and a movement route of the first moving body 10A. In this case, the setting unit 62 can set the second planned information according to the calculated workable area AR3. That is, the setting unit 62 can set the second planned information such that the work is performed outside the calculated workable area AR3. As a result, it is possible to reliably prevent interference between the first moving body 10A and the second moving body 10B.

The processing unit 64 may change the second planned information in accordance with a manner of the work of the first moving body 10A in a case where the work is performed in a manner different from the first planned information, such as a case where the first moving body 10A deviates from a predetermined route based on the first planned information, a case where the work is performed beyond a planned time period based on the first planned information, or a case where the work is completed earlier than the planned time.

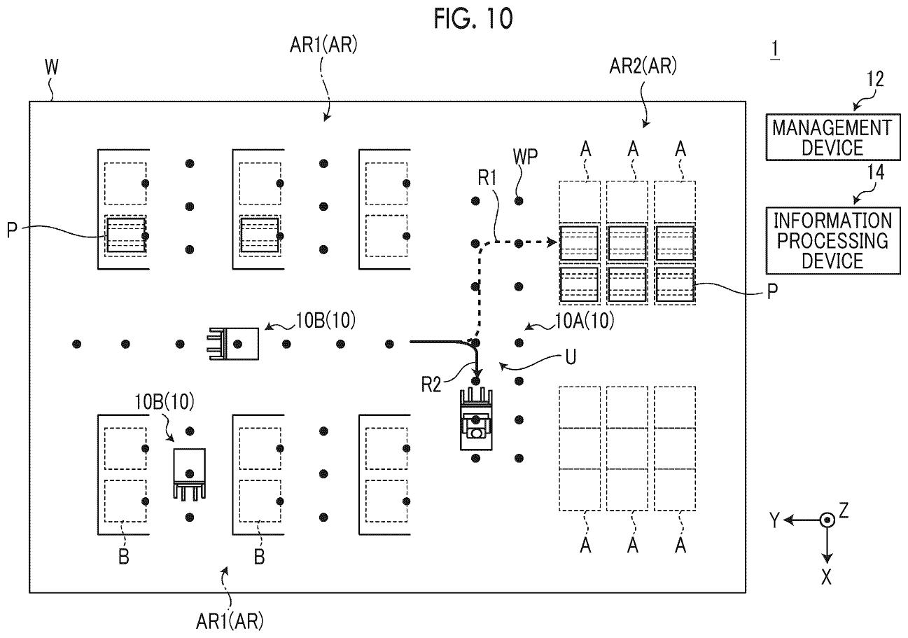

FIG. 10 is a diagram schematically showing another example of an operation of the moving body 10. As shown in FIG. 10, for example, in a case where a movement route R2 of the first moving body 10A deviates from a predetermined route R1 based on the first planned information, the processing unit 64 can change the second planned information so as to stop the work of all the second moving bodies 10B. In addition, in a case where the work of the first moving body 10A is performed beyond the planned time period based on the first planned information, the processing unit 64 can change the planned time period for the work of the second moving body 10B to be delayed. In addition, in a case where the work of the second moving body 10B is completed earlier than the planned time, the processing unit 64 can change the planned time period for the work of the second moving body 10B to be advanced.

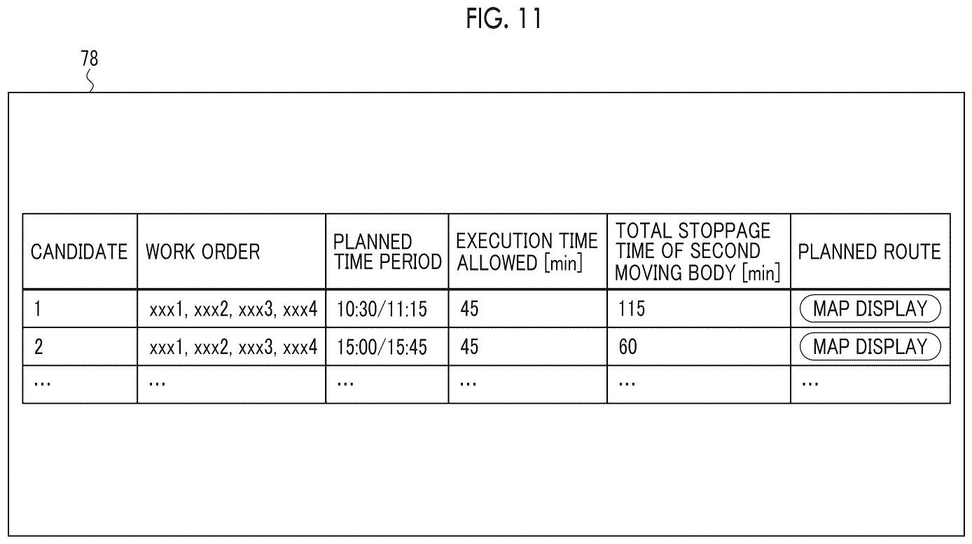

In addition, the processing unit 64 may set a plurality of candidates for the first planned information and transmit the plurality of candidates to the first moving body 10A. FIG. 11 is a diagram schematically showing an example of candidates for the first planned information displayed on the display unit 78. As shown in FIG. 11, in the first moving body 10A, the plurality of candidates are displayed on the display unit 78. In this case, a configuration may be adopted in which a movement route, a work area, and the like in which the first moving body 10A is moved based on the first planned information can be displayed on a map together with the plurality of candidates for the first planned information. The driver U can select the first planned information from the plurality of candidates displayed on the display unit 78. The driver U can input the selected first planned information using the input unit 76. The input first planned information is transmitted from the communication unit 82. The first planned information is received by the communication unit 50 of the information processing device 14. The received first planned information is acquired by the acquisition unit 60. In this way, the acquisition unit 60 acquires a selection result in which the first moving body 10A selects one of the plurality of candidates. The processing unit 64 sets the first planned information based on the acquired selection result.

### Movement of First Moving Body

The first moving body 10A, which is a manned vehicle, moves in response to an operation of the driver U. By the driver U operating the first moving body 10A based on the first planned information set as described above, the first moving body 10A can perform the work according to the first planned information.

### Movement of Second Moving Body

The second moving body 10B, which is an unmanned vehicle, performs the work according to the set second planned information. That is, the movement control unit 112 of the second moving body 10B moves the second moving body 10B in the planned time period based on the second planned information according to the route acquired by the route acquisition unit 110. More specifically, in the present embodiment, it is preferable that the route acquisition unit 110 sets a second route (global path) based on a first route (layout path) which is the movement route of the second planned information acquired from the information processing device 14. In this case, the route acquisition unit 110 sets the second route based on the first route and vehicle specification information of the second moving body 10B. The vehicle specification information is, for example, a specification that affects a route along which the second moving body 10B can move, such as the size or the minimum turning radius of the second moving body 10B. The second route is also a route toward the target position, as with the first route. Furthermore, the second route is a route that can be followed by the second moving body 10B and that leads to the target position.

The movement control unit 112 sequentially obtains the position information of the second moving body 10B to move the second moving body 10B to pass through the set route (second route in the example of the present embodiment). The method for acquiring the position information of the second moving body 10B is arbitrary, but, for example, in the present embodiment, a detection body (not shown) is provided in the facility W, and the movement control unit 112 acquires the information on the position and the posture of the second moving body 10B based on detection of the detection body. Specifically, the second moving body 10B emits laser light toward the detection body and receives reflected light of the laser light from the detection body to detect the position and the posture of the second moving body 10B in the facility W. The method for acquiring the information of the position and the posture of the second moving body 10B is not limited to the method using the detection body, and, for example, simultaneous localization and mapping (SLAM) may be used.

The second planned information is set by the information processing device 14 such that the second moving body 10B does not interfere with the work of the first moving body 10A. Therefore, by the second moving body 10B performing the work according to the second planned information, interference in work between the first moving body 10A and the second moving body 10B can be appropriately avoided.

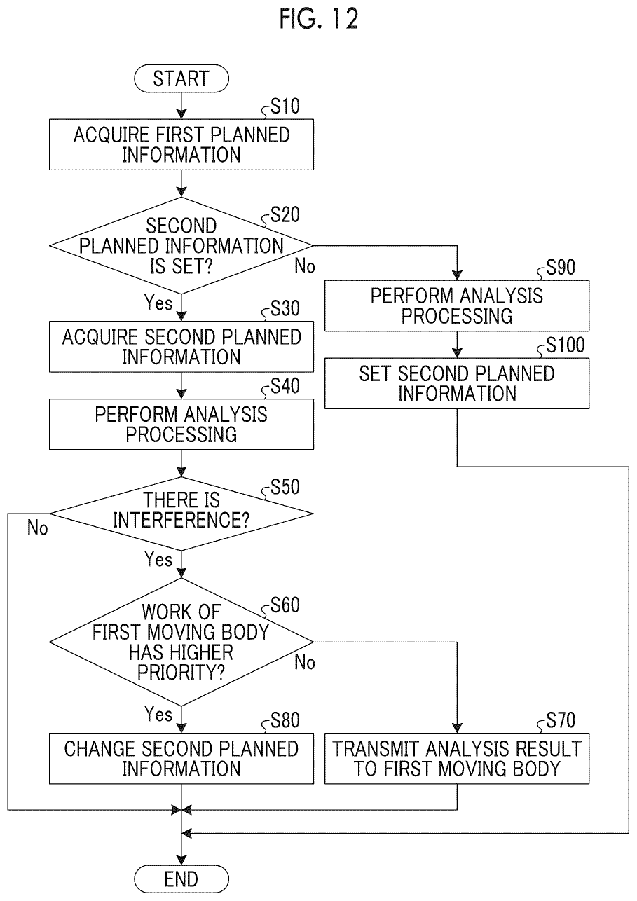

FIG. 12 is a flowchart showing an example of an operation of the information processing device 14 according to the present embodiment. As shown in FIG. 12, the information processing device 14 acquires the first planned information from the first moving body 10A in the acquisition unit 60 (step S10). The processing unit 64 determines whether or not the second planned information is set (step S20). In a case where it is determined that the second planned information is set (Yes in step S20), the processing unit 64 acquires the second planned information (step S30). The processing unit 64 analyzes interference between the work of the first moving body 10A and the work of the second moving body 10B based on the acquired first planned information and second planned information (step S40). In a case where it is determined that there is an interference time period between the work of the first moving body 10A and the work of the second moving body 10B as a result of the analysis (Yes in step S50), the priority is compared between the work of the first moving body 10A and the work of the second moving body 10B (step S60). In step S60, in a case where it is determined that the work of the first moving body 10A has a higher priority (Yes in step S60), the analysis result is transmitted to the first moving body 10A (step S70). In addition, in step S60, in a case where it is determined that the second moving body 10B has a higher priority (No in step S60), the second planned information is changed such that the second moving body 10B does not interfere with the work of the first moving body 10A (step S80).

In addition, in step S20, in a case where it is determined that the second planned information is not set (No in step S20), the processing unit 64 performs analysis processing based on the first planned information and calculates a movement route, a target position, and a planned time period that do not overlap with the first planned information as an analysis result (step S90). The processing unit 64 sets the second planned information based on the analysis result (step S100).

As described above, according to a first aspect of the present disclosure, there is provided an information processing device 14 including an acquisition unit 60 that acquires at least first planned information including a target position and a planned time period of work of a first moving body 10A that is a manned vehicle, and a processing unit 64 that analyzes interference in work between the first moving body 10A and a second moving body 10B that is an unmanned vehicle, based on the acquired first planned information.

With this configuration, the information processing device 14 can acquire information on the interference in the work between the first moving body 10A and the second moving body 10B by analyzing interference in work between the first moving body 10A and the second moving body 10B. By appropriately using the information in the information processing device 14, it is possible to suppress interference in work between the first moving body 10A and the second moving body 10B depending on a work situation while work is efficiently performed.

According to a second aspect of the present disclosure, in the information processing device 14 according to the first aspect, the acquisition unit 60 acquires second planned information including a target position and a planned time period of work of the second moving body 10B, the first planned information and the second planned information each include information related to a priority, and the processing unit 64 determines which of the first moving body 10A and the second moving body 10B is a moving body 10 that performs work with a higher priority. Therefore, by determining the priorities of the first moving body 10A and the second moving body 10B, the work can be appropriately performed in accordance with the priority.

According to a third aspect of the present disclosure, in the information processing device 14 according to the second aspect, in a case where it is determined that the second moving body 10B performs the work with the higher priority than the first moving body 10A, the processing unit 64 transmits a result of the analysis to the first moving body 10A. Therefore, the driver U can be prompted to reset the first planned information of the first moving body 10A to match the second moving body 10B performing the work with the higher priority.

According to a fourth aspect of the present disclosure, in the information processing device 14 according to the third aspect, the processing unit 64 transmits information in which the result of the analysis and the second planned information are associated with each other by time to the first moving body 10A. Therefore, when prompting the driver U to reset the first planned information, appropriate information can be presented to the driver U so that the driver U can easily disregard the second planned information of the second moving body 10B.

According to a fifth aspect of the present disclosure, in the information processing device 14 according to the second aspect, in a case where it is determined that the first moving body 10A performs the work with the higher priority than the second moving body 10B, the processing unit 64 changes the second planned information of the second moving body 10B based on a result of the analysis such that the second moving body 10B does not interfere with the first moving body 10A that performs the work according to the first planned information. Therefore, the second planned information of the second moving body 10B can be automatically changed to match the first moving body 10A performing the work with the higher priority.

According to a sixth aspect of the present disclosure, the information processing device 14 according to the first aspect further includes a setting unit 62 that sets the second planned information of the second moving body 10B based on a result of the analysis such that the second moving body 10B does not interfere with the first moving body 10A that performs the work according to the first planned information. Therefore, the second planned information can be efficiently set.

According to a seventh aspect of the present disclosure, in the information processing device 14 according to the sixth aspect, the processing unit 64 sets a plurality of candidates for the first planned information, and presents the plurality of candidates to the first moving body 10A, the acquisition unit 60 acquires a selection result in which the first moving body 10A selects one of the plurality of candidates, and the processing unit 64 sets the first planned information based on the acquired selection result. Therefore, it is possible to broaden a range of options available to the driver U regarding the work plan.

According to an eighth aspect of the present disclosure, in the information processing device 14 according to the sixth aspect, the processing unit 64 calculates a workable area in which the first moving body 10A is capable of performing the work, based on the result of the analysis, and the setting unit 62 sets the second planned information according to the calculated workable area. Therefore, it is possible to appropriately avoid interference between the first moving body 10A and the second moving body 10B.

According to a ninth aspect of the present disclosure, in the information processing device 14 according to the sixth aspect, in a case where the first moving body 10A performs the work in a manner different from the first planned information, the processing unit 64 changes the second planned information in accordance with a manner of the work of the first moving body 10A. Therefore, the work plan of the second moving body 10B can be flexibly changed according to the work state of the first moving body 10A. Therefore, it is possible to suppress interference between the first moving body 10A and the second moving body 10B.

According to a tenth aspect of the present disclosure, in the information processing device 14 according to the sixth aspect, the setting unit 62 sets the second planned information each time the first planned information is acquired. Therefore, in a case where the first moving body 10A performs new work, the second moving body 10B performs the work based on the second planned information that is appropriately set each time. Therefore, it is possible to appropriately avoid interference between the first moving body 10A and the second moving body 10B.

According to an eleventh aspect of the present disclosure, there is provided a moving body control method including a step of acquiring at least first planned information including a target position and a planned time period of work of a first moving body 10A that is a manned vehicle, and a step of analyzing interference in work between the first moving body 10A and a second moving body 10B that is an unmanned vehicle, based on the acquired first planned information.

With this configuration, it is possible to acquire information on the interference in the work between the first moving body 10A and the second moving body 10B by analyzing interference in work between the first moving body 10A and the second moving body 10B. By appropriately using this information, it is possible to suppress interference in work between the first moving body 10A and the second moving body 10B.

According to a twelfth aspect of the present disclosure, there is provided a moving body control program causing a computer to execute a process of acquiring at least first planned information including a target position and a planned time period of work of a first moving body 10A that is a manned vehicle, and a process of analyzing interference in work between the first moving body 10A and a second moving body 10B that is an unmanned vehicle, based on the acquired first planned information.

With this configuration, it is possible to acquire information on the interference in the work between the first moving body 10A and the second moving body 10B by analyzing interference in work between the first moving body 10A and the second moving body 10B. By appropriately using this information, it is possible to suppress interference in work between the first moving body 10A and the second moving body 10B.

Although the embodiment of the present disclosure has been described above, the embodiment is not limited by the contents of the embodiment. In addition, the above-described components include those that can be easily assumed by those skilled in the art, those that are substantially the same, and those that are within a so-called equivalent range. Further, the above-described components can be combined as appropriate. Furthermore, various omissions, replacements, or modifications of the above-described components can be made without departing from the concept of the above-described embodiment.

### REFERENCE SIGNS LIST

1: movement control system
10: moving body
10A: first moving body
10B: second moving body
12: management device
14: information processing device
20: vehicle body
20A: wheel
21: straddle leg
22: mast
24: fork
24A, 24B: fork
26A: sensor
28, 80: control device
30, 50, 82, 100: communication unit
32, 52, 84, 102: storage unit
34, 54, 86, 104: control unit
40: work order setting unit
60; acquisition unit
62: setting unit
64: processing unit
70: operation unit
72: drive unit
74: imaging unit
76: input unit
78: display unit
78a: indicator
88; position estimation unit
90, 114: information transmission unit
92, 112: movement control unit
110: route acquisition unit
A: disposition region
B: storage region
P: object
P0: fixed object
R1: route
R2: movement route
U: driver
V: transport vehicle
ID: order
W: facility
X, Z: direction
AR: work region
AR1: first region
AR2: second region
AR3: workable area
WP: waypoint

1. An information processing device comprising:
an acquisition unit that acquires at least first planned information including a target position and a planned time period of work of a first moving body that is a manned vehicle; and
a processing unit that analyzes interference in work between the first moving body and a second moving body that is an unmanned vehicle, based on the acquired first planned information.

2. The information processing device according to claim 1,
wherein the acquisition unit acquires second planned information including a target position and a planned time period of work of the second moving body,
the first planned information and the second planned information each include information related to a priority, and
the processing unit determines which of the first moving body and the second moving body is a moving body that performs work with a higher priority.

3. The information processing device according to claim 2,
wherein, in a case where it is determined that the second moving body performs the work with the higher priority than the first moving body, the processing unit transmits a result of the analysis to the first moving body.

4. The information processing device according to claim 3,
wherein the processing unit transmits information in which the result of the analysis and the second planned information are associated with each other by time to the first moving body.

5. The information processing device according to claim 2,
wherein, in a case where it is determined that the first moving body performs the work with the higher priority than the second moving body, the processing unit changes the second planned information of the second moving body based on a result of the analysis such that the second moving body does not interfere with the first moving body that performs the work according to the first planned information.

6. The information processing device according to claim 2, further comprising:
a setting unit that sets the second planned information of the second moving body based on a result of the analysis such that the second moving body does not interfere with the first moving body that performs the work according to the first planned information.

7. The information processing device according to claim 6,
wherein the processing unit sets a plurality of candidates for the first planned information, and presents the plurality of candidates to the first moving body,
the acquisition unit acquires a selection result in which the first moving body selects one of the plurality of candidates, and
the processing unit sets the first planned information based on the acquired selection result.

8. The information processing device according to claim 6,
wherein the processing unit calculates a workable area in which the first moving body is capable of performing the work, based on the result of the analysis, and
the setting unit sets the second planned information according to the calculated workable area.

9. The information processing device according to claim 6,
wherein, in a case where the first moving body performs the work in a manner different from the first planned information, the processing unit changes the second planned information in accordance with a manner of the work of the first moving body.

10. The information processing device according to claim 6,
wherein the setting unit sets the second planned information each time the first planned information is acquired.

11. A moving body control method comprising:
a step of acquiring at least first planned information including a target position and a planned time period of work of a first moving body that is a manned vehicle; and
a step of analyzing interference in work between the first moving body and a second moving body that is an unmanned vehicle, based on the acquired first planned information.

12. A non-transitory computer-readable recording medium having stored thereon a moving body control program causing a computer to execute:
a process of acquiring at least first planned information including a target position and a planned time period of work of a first moving body that is a manned vehicle; and
a process of analyzing interference in work between the first moving body and a second moving body that is an unmanned vehicle, based on the acquired first planned information.
